(19) United States
(12) Patent Application Publication
(10) Pub. No.: US 2026/0113213 A1
(43) Pub. Date: Apr. 23, 2026

(54) LINK LOAD BALANCING IN FABRIC NETWORKS

(71) Applicant: Akamai Technologies, Inc., Cambridge, MA (US)

(72) Inventor: Byung (Peter) K. Choi, Ypsilanti, MI (US)

(21) Appl. No.: 18/921,389

(22) Filed: Oct. 21, 2024

(51) Int. Cl. H04L 12/46; H04L 47/125; H04L 47/2483

(52) U.S. Cl. CPC H04L 12/4633; H04L 47/125; H04L 47/2483

(57) ABSTRACT

Imbalances in link utilization across fabric networks can be addressed by setting up an overlay network on top of the fabric. The overlay network can be implemented as a set of tunnels that each traverse the fabric or a portion thereof. The tunnels may be instantiated on-demand when imbalances are detected. By assigning traffic groups to tunnels and using tunnel information as inputs to an equal cost multi path (ECMP) type hashing algorithm, the traffic across the fabric can be spread amongst links in a more balanced fashion. To address an imbalance condition, all or just a portion of the traffic across the fabric may be assigned to tunnels. The teachings hereof apply with limitation to fabric networks in data centers that connect large sets of computing resources to the Internet or other egress points.

### BACKGROUND

### Technical Field

This document generally relates to the management and load balancing of network traffic in computer networks.

### Brief Description of the Related Art

Distributed computer systems are well-known in the prior art. One such distributed computer system is a “content delivery network” (CDN) or “overlay network” that is operated and managed by a service provider. The service provider typically provides the content delivery service on behalf of third parties (customers) who use the service provider's shared infrastructure. A distributed system of this type typically refers to a collection of autonomous computers linked by a network or networks, together with the software, systems, protocols and techniques designed to facilitate various services, such as content delivery, web application acceleration, or other support of outsourced origin site infrastructure. A CDN service provider typically provides service delivery through digital properties (such as a website), which are provisioned in a customer portal and then deployed to the network.

Cloud computing is an information technology delivery model by which shared resources, software and information are provided on-demand over a network (e.g., the publicly-routed Internet) to computers and other devices. This type of delivery model has significant advantages in that it reduces information technology costs and complexities, while at the same time improving workload optimization and service delivery. In a typical use case, an application is hosted from network-based resources and is accessible through a conventional browser or mobile application. Cloud compute resources typically are deployed and supported in data centers that run one or more network applications, typically using a virtualized architecture wherein applications run inside virtual servers, or virtual machines (VMs), which are mapped onto physical servers in the data center. The virtual machines typically run on top of a hypervisor, which allocates physical resources to the virtual machines.

A modern internet infrastructure provider may support both CDN and on-demand cloud computing (and other services) from large deployments of servers housed in data centers. FIG. 1 is a diagram illustrating an example of a fabric network as known in the art. The fabric network in FIG. 1 may be implemented as a non-blocking, multistage switching network (e.g., CLOS) with Border Gateway Protocol (BGP) as the routing protocol. A fabric network typically utilizes a mesh of links between network devices (such as switches and routers in FIG. 1). The term mesh indicates that links are laterally connected as well as hierarchically top to bottom.

Starting from the bottom of FIG. 1, the infrastructure contains many racks of host machines (H) which are connected to a top of rack (ToR) switch. A typical host machine would be a multi-core server running an operating system such as Linux and other applications and services, such as CDN proxy server and/or guest VM functions. The host machines are generally connected with one or more ToR switches with a physical ethernet cable to each of them.

The ToR switch facilitates connectivity between hosts in a rack and between those hosts and the rest of a network fabric. The ToR switch is the ingress point to the fabric network.

Upstream (north) of the ToR is a set of devices, in this example leaf (also referred to as bolt) and spine routers, which connect to the stem routers above. Routing between hosts and the other network devices is done through BGP; all hosts speak BGP with the devices they have a physical connection with. In some designs, the hosts have an eBGP connection with one or more instances of a route server, which acts as a distributed network controller. In those designs, the route server may execute a route server manager process that performs leader election and starts/stops route server instances as needed. The hosts use an Internet routing protocol suite (e.g., FRR or FRRouting) to establish eBGP connections to the TORs and route servers and install routes in the Linux kernel.

The border signifies the egress from the provider's infrastructure to the internet and/or the networks of other entities via transit links. The border routers are at the top of the diagram.

It should be understood that FIG. 1 is merely one example and many other implementations are possible depending on design goals. The number of stages may vary; a switch may be used instead of a router and vice versa, and the number of connections from and to each device may vary, for example.

When network packets arrive at a given network device in FIG. 1, such as a switch or router, it must determine which outbound link to use for sending them onwards, as generally there will be multiple potential paths (as shown in FIG. 1). Network devices use well known algorithms referred to as equal cost multi-path (ECMP) algorithms for this purpose. ECMP algorithms often use a hash function applied to a tuple from the network packet headers (often a set of IP header fields, and in some implementations, TCP header fields too). This tuple is commonly said to refer to a “flow”. The hash function produces a numerical output within a range. That range is divided up into segments, each of which corresponds to an output link to use for sending the packet. Hence, the output of the hash function associates the flow to an output link in a consistent manner.

ECMP algorithms often perform poorly in practice, particularly in fabric networks such as that shown in FIG. 1. Certain links within the fabric will exhibit high utilization, and congested flows, while other links are much less loaded. Link utilization imbalance is costly and wasteful. Centralized or managed load balancing algorithms have been proposed to address link imbalance and to measure and address congestion, but they are complex to implement and costly to run. See Alizadeh et al., CONGA, Cisco Systems SIGCOMM 2014. Another known approach includes rerouting flows that experience congestion; rerouting can be accomplished using VxLAN header manipulation. See M. Qureshi et al., PLB: Congestion Signals are Simple and Effective for Network Load Balancing, SIGCOMM 2022. But this approach requires measuring and managing traffic at the TCP flow level, which can be computationally heavy when scaled.

The teachings hereof provide improved load balancing in fabric networks to address link utilization imbalances and congestion. The teachings hereof apply without limitation to fabric networks such as that illustrated and described in connection with FIG. 1.

Generalizing, the teachings presented herein improve the functioning of computer systems themselves. Those skilled in the art will understand these and other improvements from the teachings hereof.

### BRIEF SUMMARY

This section describes some pertinent aspects of this invention. Those aspects are illustrative, not exhaustive, and they are not a definition of the invention. The claims of the issued patent define the scope of protection.

Imbalances in link utilization across fabric networks can be addressed by setting up an overlay network on top of the fabric. The overlay network can be implemented as a set of tunnels that each traverse the fabric, or the portion thereof that is congested. The tunnels may be instantiated on-demand when imbalances are detected, or may be created in advance and persisted. By assigning traffic groups to tunnels and using tunnel header information as inputs to an equal cost multi path (ECMP) type hashing algorithm, the traffic across the fabric can be spread amongst links in a more balanced fashion. To address an imbalance condition, all or just an affected portion of the traffic across the fabric may be assigned to tunnels. The teachings hereof apply with limitation to fabric networks in data centers that connect large sets of computing resources to the Internet, transit, or other egress.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a diagram of a known (prior art) fabric network such as might be found in a data center connecting server racks to network egress points at the border routers;

FIG. 2 is a diagram illustrating a process for monitoring and mitigating link imbalances in fabric networks, in accordance with an embodiment of the teachings hereof;

FIG. 3 is diagram illustrating the fabric network of FIG. 1 with an example of detected link utilization imbalances;

FIG. 4 is diagram illustrating the fabric network of FIG. 1 with another example of detected link utilization imbalances;

FIG. 5 is a diagram illustrating before and after mitigation of link overload in network devices using ECMP algorithms, in accordance with an embodiment of the teachings hereof; and,

FIG. 6 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

While context may indicate the hardware or the software exclusively, should such distinction be appropriate, the teachings hereof can be implemented in any combination of hardware and software. Hardware may be actual or virtualized.

### Link Imbalances and Mitigation

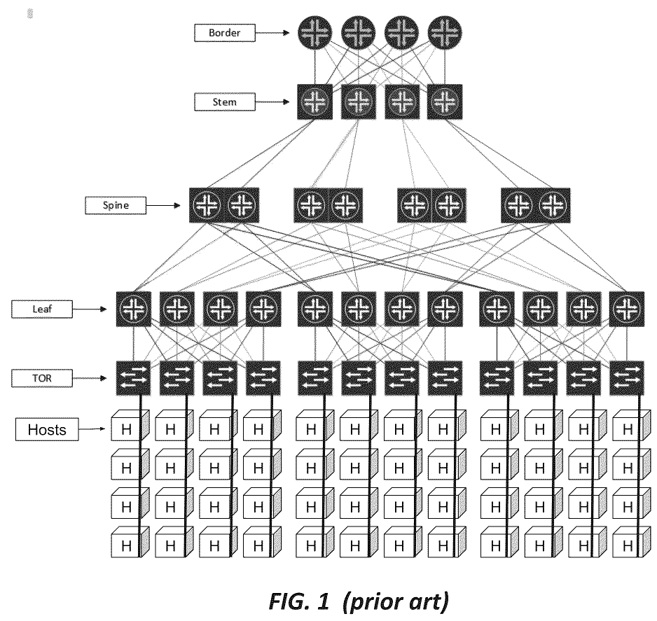

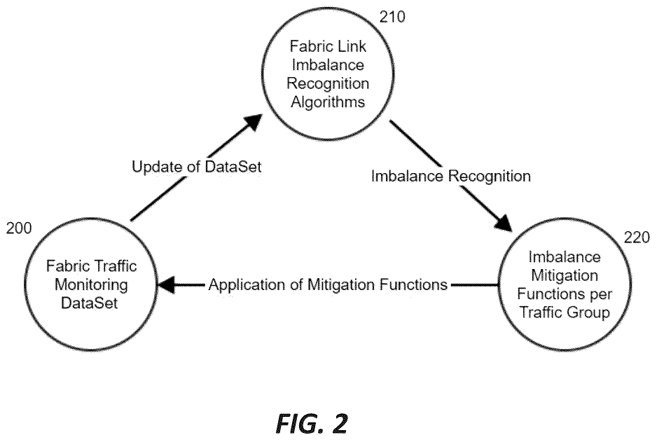

FIG. 2 illustrates a process for link imbalance and mitigation. A fabric network, such as that shown in FIG. 1, can be monitored for link imbalances. Link imbalances trigger mitigations, which then affect the monitored traffic in a closed loop process. Mitigations in this context refers to, without limitation, the instantiation of tunnels and assignment of traffic to the tunnels for traversing the fabric, as described in more detail later in this document.

It should be understood that FIG. 2 relates to an on-demand embodiment, in which mitigation is applied responsive to the detection of link imbalances. In some embodiments of the teachings hereof, mitigations can be set up in advance, and can be adjusted or modified when imbalances are detected.

Link imbalance monitoring begins at step 200. Preferably, monitoring captures the load on links across the fabric network shown in FIG. 1. This can be done via a network tap and packet capture tool, and/or using native functionality on the routers and switches and other network devices, or other known techniques. This link data can be updated in near real-time, e.g., every 30 seconds, so as to follow the dynamics of the imbalance.

Examples of metrics for link reporting include:
Per link metrics
   ifInOctets, ifOutOctets—byte counts per interface
   ifspeed—link speed or line rate
   ifDirection—inbound or outbound
   ifInUtilization—inbound link utilization-->(ifInOctets×8)/ifspeed
   ifOutUtilization—outbound link utilization→(ifOutOctets×8)/ifspeed
   Out2InRate—outbound to inbound traffic ratio, per link, derived
Per stage metrics of Clos network topology (Leaf, Spine, Stem)
   SumInOctets—total inbound bytes count, derived
   SumOutOctets—total outbound bytes count, derived
Imbalance metrics
   ifOutUtilAvg—average link utilization rate of the given stage (leaf, spine, stem) observed, derived
   ifOutUtilMax—max/highest link utilization observed
   ifOutUtilMin—min/lowest link utilization observed
   ifOutUtilDev—statistical standard deviation of link utilization, derived, Deviation_(statistics)
   ifOutUtilM2A—max to average ratio, ifOutUtilMax/ifOutUtilAvg, derived
   ifOutUtilMax2Min—max to min ratio, ifOutUtilMax/ifOutUtilMin, derived
Severity of imbalance
   RED—ifOutUtilM2A>100 or ifOutUtilMax2Min>1,000
   YELLOW—10<ifOutUtilM2A<=100 or 100<ifOutUtilMax2Min<=1000
   Green—Ifoututilm2a<=10 or Ifoututilmax2min<=100

Link load metrics can be reported by traffic groups. The term ‘traffic group’ is used herein to denote a portion of network traffic that can be reliably identified and distinguished from other traffic. Sometimes, network traffic is discussed in terms of “flows”, which typically refer to IP/TCP packet header tuples (eg., source IP, dest IP, source port, dest port). A traffic group can be a flow, or an aggregation of multiple flows, but it does not necessarily need to be composed of flows. A traffic group might be defined by IP address (that is, by CIDR block); by service type (e.g., CDN, compute services, control services, etc.); by network entity (e. g, by link, by rack); by customer or tenant (e.g., domain or other identifier), or in other ways. Traffic groups are usually configurable and defined by a configuration that specifies the criteria of each group.

Monitoring data is the input to an imbalance recognition algorithm(s) 210. A variety of algorithms may be used to calculate and determine the threshold for actionable imbalance across the links. Preferably, the time to execute the algorithm(s) is shorter than the monitoring cycle. So for example, the monitoring data can be updated at T0, T1, T2, such that T(n) is the monitoring data updated at the n-th cycle. Preferably, T(n)+algorithmic-time<<T(n+1).

The monitoring algorithm can be triggered by the availability of a new dataset of link utilization. Preferably, the algorithm assesses link utilization by traffic groups for each link in the fabric. Results can be reported to show imbalance patterns (by stage, by route path), imbalance degree by bandwidth consumption distribution (by stage, by route), stages and routes that need immediate attention for mitigation, and/or Top-N traffic groups contributing to the link/path overload (by stage, by route).

For example, imbalance by stage in the fabric network. In other words, one or more disproportionately overloaded links might be identified in one of the following stages:
ToR to Leaf
Leaf to Spine
Spine to Stem
Stem to Border

Imbalance can also be identified by route/path. For example, a sequence of links creating a route might be identified as disproportionately overloaded, where the route is:
ToR to Leaf to Spine
ToR to Leaf to Spine to Stem to Border
ToR1 to Leaf1 to Spine to Leaf2 to ToR2

Also possible is identifying imbalance by combination of stage and route. For example, each stage might have one disproportionately overloaded link, and also the overloaded link in each stage is found to be connected to one another in a sequence creating a complete route from ToR to Border. Hence the individual stage links are identified as overloaded, as is the route.

In one implementation, a process for detecting link imbalance can proceed as follows. Assume that in a fabric like that shown in FIG. 1., the first stage (from ToR to Leaf) has a total of 32 links, each of which has 10Gb/s capacity. At the T(n) cycle, the average utilization of all 32 links is measured to be 5% or about 500 Mb/s per link. However, one of the links is at 70% utilization or 7 Gbp/s, while the lightest loaded link is at 0.5% or 50 Mb/s. Given these measurements, the ratio of the high load link to the average load is 7 G/500M=14. The maximum link to minimum link ratio is 7 G/50M or 140.

The foregoing statistics can be compared to configured thresholds. For example, they may indicate a “yellow” imbalance, meaning that the imbalance recognition algorithms can wait one more cycle T before triggering a mitigation action. If the “yellow” status gradually goes down toward ‘green’ in the following few cycles, the mitigation action would not be triggered. This is an example of how the mitigation is triggered with theoretical thresholds. Different fabrics may have different thresholds to optimize the overall mitigation efficiency, and such thresholds and indeed the statistics to be considered are design choices that may vary across implementations.

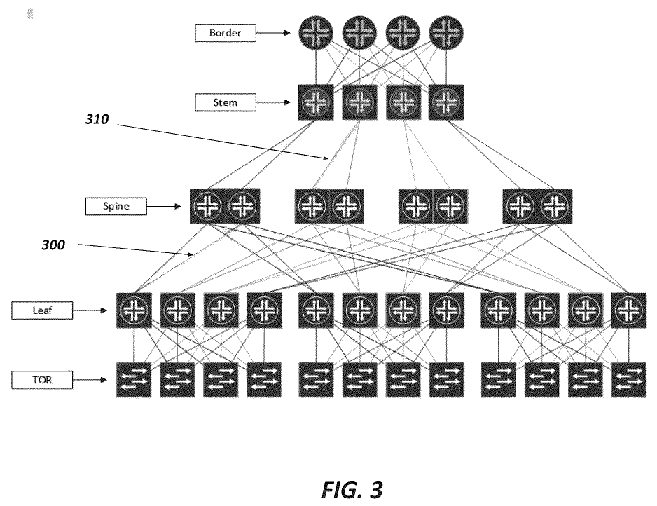

FIG. 3 is a diagram indicating two links overloaded (300 and 310) independently of each other. One link 300 is from Leaf to Spine, and the other is from Spine to Stem.

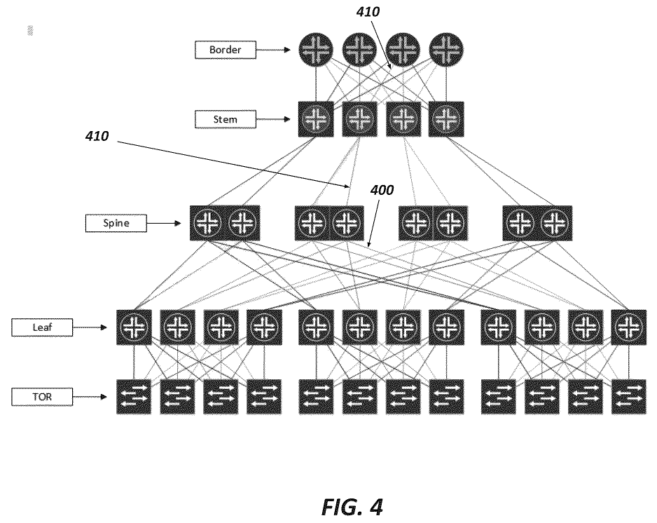

FIG. 4 is a diagram indicating three links overloaded (400, 410, 420) possibly by the same traffic group from Leaf to Spine, Spine to Stem, and Stem to Border.

Upon recognition of an imbalance in the fabric network, control moves to 220 in FIG. 2. Mitigation can be applied to the affected traffic groups, or to the Top N traffic groups in the fabric (or in the affected links).

### Root Causes of Link Imbalance

Imbalances in link utilization are due largely to limitations of ECMP hash functions when applied against the information from packet header fields as the input. The input space, a combination of the packet header fields (for example: src IP, dest IP, srcPort, destPort, protocol) fails to reflect the traffic volume. So even in the case of perfect distribution of the large input space to a small set of output links, the traffic load can concentrate on a subset or even a single link of the available links. The input space is typically not especially large, meaning that the distribution of the input values across the input range tends to be insufficiently uniform. For example, the input value may be clustered (e.g., around particular IP spaces) or otherwise similar or restricted in variety.

Simulations of the operation of the ECMP algorithm are challenging. For example consider a hash function such as crc16, crc32-hi, crc16-ccit, crc32-lo. Assume an output space: 8, 16, 32 links, for example. Theoretically, one might try to simulate the operation of the ECMP hash function by considering all possible inputs to the hash function (all combinations of allowed packet header fields, e.g.) and all possible quantized traffic load levels per each combination of the allowed packet header information fields. From a high level, one can consider the theoretically possible hash collisions on a subset or even a single link as a case of birthday paradox and use this model to understand how to address link imbalances. But as can be seen from the size of the input and output spaces, such an approach is challenging and not particularly practical, even with the traffic load levels being quantized.

ECMP algorithms and their hash functions are typically hard coded (e.g., in an ASIC) into routers, switches, and other network devices in the fabric network. It is difficult to change the algorithms at all, much less on-demand. Even if those algorithms or hash functions could be changed, the cost of running more complex algorithms at the necessary line speeds may be prohibitive.

This disclosure contemplates that, instead of altering the algorithm or the hash function itself, the input to the hash function can be altered in a strategic way to mitigate link imbalances and congestion. To do this, the original network packets can be tunneled over the fabric network (or a portion thereof). The tunnels can be implemented with an encapsulating protocol such as GRE. The tunnel header can be arbitrarily modified for hash-redistribution while the original packet remains intact, thus preserving the integrity of the underlying packet flows. This means that the tunnels can begin at the beginning of the fabric (the ToR device) and end at the border device in FIG. 1. Alternatively, they can extend across a portion of the fabric that is experiencing link imbalance.

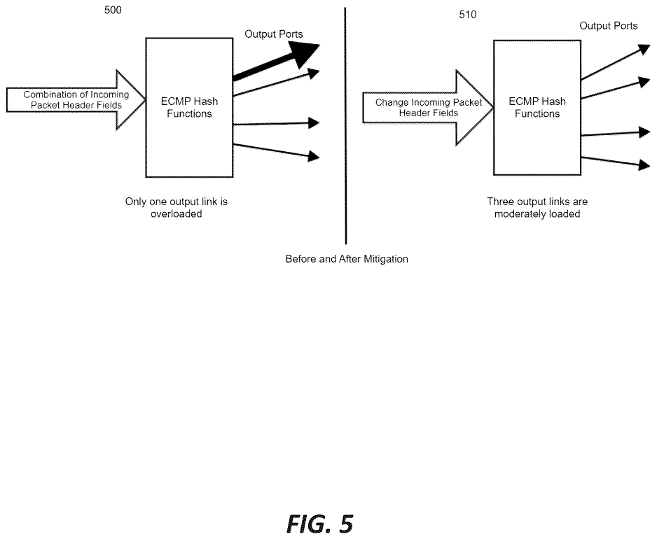

FIG. 5 illustrates the concept of altering the input to the hash function. During normal operation shown on the left side 500, a combination of packet header fields is used as an input to the hash function. When this results in a link imbalance, as indicated by the larger arrow at the top of the left side 500, the mitigation is invoked.

Mitigation and post-mitigation is shown on the right side, 510. In one embodiment, mitigation generally proceeds as follows: a set of tunnels is instantiated and the incoming traffic is distributed across the tunnels. This means that a network device at the beginning of the tunnel examines network packets to classify them into a traffic group. Each traffic group is mapped to a set of one or more tunnels. Preferably the volume of traffic in each tunnel is similar. The tunnels are used as the input to the ECMP algorithm. This means that the tunnel headers provide a different combination of packet header fields and values (more generally: information) can be inserted into those fields (particularly unused or optional fields) to spread the input space to the hash algorithm. This means the input space is more spread out, more diverse, or otherwise closer to a uniform distribution than beforehand. As a consequence, the hash function performs better and the traffic is spread more evenly over the output links, as shown on the right 510.

In an on-demand embodiment, the tunnels are instantiated on-demand when mitigation is needed. In a persisted tunnel embodiment, the tunnels are set up ahead of time, and mitigation is always applied, or mitigation is done by changing or rotating the information in the packet header fields of the tunnel.

### Assignment of Packets or Flows to Traffic Groups

Mitigation can be applied to a select number of traffic groups. The selected groups are typically the Top-N groups that are on the overloaded links.

As mentioned above, traffic groups may be defined in a variety of ways via configuration. Examples include defining a traffic group by IP address (CIDR block), by rack, by service, by product (e.g., application layer information).

Preferably, traffic grouping is flexible and configured in software.

### Tunnel Overlay

A tunnel overlay is created by instantiating a set of tunnels across the fabric network, or at least a portion thereof experiencing problems. A tunnel can be created by encapsulating network packets in the payload of an outer packet, e.g., with its own packet header fields. Generic Routing Encapsulation (GRE, RFC 2784) is a widely known and widely supported protocol that can be used for that purpose. IP in IP encapsulation can be used. Generalizing, any tunneling or encapsulating protocol consistent with the teachings hereof can be used. The term tunnel packet is used herein to refer to the original packet with the tunnel and/or encapsulation applied. The headers of the tunneling protocol are generally referred to herein as the tunnel packet headers, or tunnel headers.

Using GRE as illustration, the delivery header of an IP/TCP packet combined with the GRE header provides ample opportunity to control the input values to the ECMP hash algorithm and mitigate the root cause issues identified above. One example is to include a value in ‘Reserved1’, which is a 16-bit optional field in a GRE header, into the hash function input. Other optional fields can be used as well, as can any field that does not interfere with the operation of the tunnel. The value can be selected or algorithmically generated so as to spread the input space to the hash function of the ECMP algorithm. In an implementation where tunnels are set up ahead of time, and existing before link imbalance, the value of this field can be changed to another value (e.g., randomly) when required to change the hash input upon the detection of link imbalance. The selection and/or generation of the value for the field is discussed in more detail in a subsequent section of this document.

In a further embodiment, IP in IP tunneling can be used and the input values to the ECMP hash function can be controlled by including a value in the ToS (type of service) in the IPv4 header (or the Flow Label in the IPv6 header). In an implementation where tunnels are set up ahead of time, and existing even before link imbalance, the value of this ToS/Flow Label can be changed (e.g., randomly) when required to change the hash inputs upon the report of link imbalance/overload. As those skilled in the art will recognize, the ToS and Flow Label fields could be used with the aforementioned embodiments.

Preferably, the tunnels extend from the ToR devices (in FIG. 1) to the border devices. For compute traffic, which may leverage hypervisors on the hosts (e.g., KVM and QEMU), the tunnels can begin in the hypervisor and extend to the border devices. Alternatively, the tunnels for compute traffic can be implemented similarly to the rest of the traffic, that is from ToR devices (in FIG. 1) to the border devices, so as to have a unified implementation.

Alternatively, a software switch in the host (such as Open vSwitch, an open source package) can serve as the endpoint of the tunnel at the bottom of the fabric, rather than the ToR.

### ECMP Assignment of Traffic Groups to Tunnels

When mitigation is active, a network device at the entrypoint/ingress of the tunnel (e.g., the ToR device, or a device supporting that device inline) applies a filter to the traffic to identify traffic groups as defined in a configuration, and to associate traffic groups to an assigned tunnel. The information in the tunnel header fields in the tunneled packets are then used (alone or in combination with the original packet headers) as input to the ECMP hash algorithm to generate value in a range, as per standard operation. A segment of the range corresponds to an output link, so the operation of the hash algorithm effectively distributes tunnel packets amongst the output links. The ECMP hash algorithm itself need not be modified and can be implemented in a prior art fashion.

### Selecting Tunnel Packet Header Values

Values for the tunnel headers (such as the optional ‘Reserved1’ field) are selected or generated so that the range of the input space to the hash algorithm is broader than the flow-based tuples that are used in the prior art.

Here are two examples of how to select or generate the values inserted into the tunnel headers for the above purpose:
a. Use GRE tunneling, using the ‘Reserved1’ field as the sole input field to the ECMP hash function. Traffic groups can be mapped to predetermined values for Reserved1. The predetermined values are designed to produce hash function results that evenly distribute the input Reserved1 values to the output links. This can be referred to as a static source routing.
b. Use GRE tunneling, using a random value in the ‘Reserved1’ field plus the values in the other header field tuples (e. g, IP header fields, and/or TCP header fields). Upon the detection of an actionable imbalance, the random value is changed to another random value. Some of the traffic groups of the overloaded links will be redistributed to other links in a random fashion. The imbalance condition will be responded to quickly and automatically this way. Preferably, the hash input for some groups (e.g., the Top-N traffic groups by volume) rather than all groups. The selection of which groups to change and how many (N) can be determined via experimentation and careful configuration. It is desirable to test such scenarios to avoid simply causing another overloaded link and/or oscillation in the link imbalances.

### VxLAN for Tunnels

In an alternative embodiment, the VxLAN protocol (RFC 7348) can be used as the tunneling mechanism. VxLAN is referred to as a layer 2 overlay scheme on a layer 3 network. VxLAN provides the ability to define network segments that isolate traffic into tunnels. Network segments are defined by the VxLAN header, which contains a segment identifier as well as flags and reserved fields. Hence, VxLAN header presents an opportunity to select and/or control the input values to the ECMP hash algorithm and mitigate the root cause issues identified above, in a manner similar to that of the GRE and IP in IP tunneling, discussed earlier.

The VxLAN header encapsulates a MAC address and is itself typically wrapped by a UDP header and an IP header. As a result, a VxLAN tunnel typically requires careful consideration and configuration at layer 2. It can be more complex in some data centers and fabric networks, at least relative to earlier embodiments of GRE and Ip-in-IP tunneling. Nevertheless it remains a possible embodiment of the teachings hereof.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus - such as a microprocessor in a computer, digital data processing device, or other computing apparatus - as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

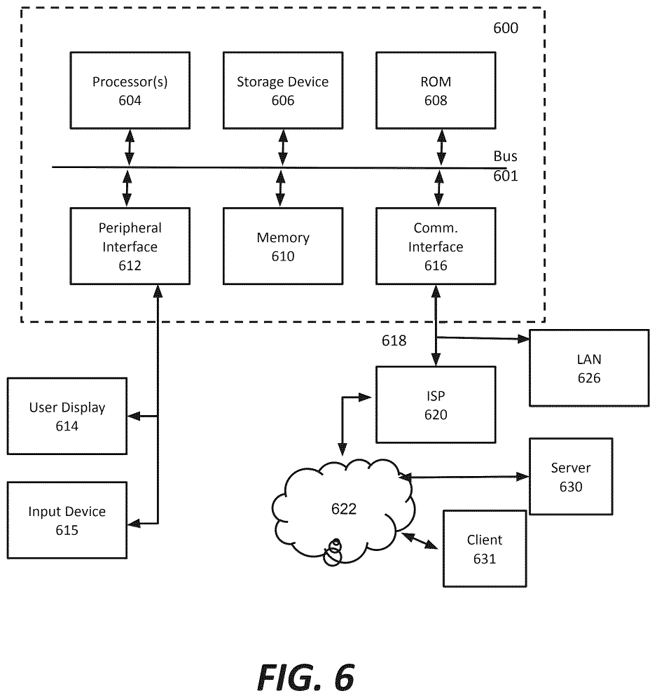

FIG. 6 is a block diagram that illustrates hardware in a computer system 600 upon which such software may run in order to implement embodiments of the invention. The computer system 600 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 600 includes a microprocessor 604 coupled to bus 601. In some systems, multiple processor and/or processor cores may be employed. Computer system 600 further includes a main memory 610, such as a random access memory (RAM) or other storage device, coupled to the bus 601 for storing information and instructions to be executed by processor 604. A read only memory (ROM) 608 is coupled to the bus 601 for storing information and instructions for processor 604. A non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

A peripheral interface 612 may be provided to communicatively couple computer system 600 to a user display 614 that displays the output of software executing on the computer system, and an input device 615 (e.g., a keyboard, mouse, trackpad, touchscreen) that communicates user input and instructions to the computer system 600. However, in many embodiments, a computer system 600 may not have a user interface beyond a network port, e.g., in the case of a server in a rack. The peripheral interface 612 may include interface circuitry, control and/or level-shifting logic for local buses such as RS-485, Universal Serial Bus (USB), IEEE 1394, or other communication links.

Computer system 600 is coupled to a communication interface 616 that provides a link (e.g., at a physical layer, data link layer,) between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the processor executing code. Such code may be read from or stored on a non-transitory computer-readable medium, such as memory 610, ROM 608, or storage device 606. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 618 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method of load balancing traffic flowing across a fabric network, the method comprising:
instantiating a plurality of tunnels that each traverse at least a portion of a fabric network from a first device to a second device;
receiving network packets at the first device, and classifying the network packets into a plurality of traffic groups based at least in part on information in the network packets;
placing network packets for a given traffic group into at least one tunnel of the plurality of tunnels;
assigning each of the plurality of tunnels to an outbound link on the first device, at least in part by applying an equal cost multi path (ECMP) algorithm to a set of tunnel header fields, wherein applying the ECMP algorithm comprises applying a hash function over at least the set of tunnel header fields; and,
transmitting network packets in each tunnel from the respective assigned outbound link over a next hop in the fabric network.

2. The method of claim 1, where said instantiating, receiving, assigning, and transmitting are performed on-demand, in response to a detection of link imbalance in a fabric network.

3. The method of claim 1, where the first device comprises any of: a router and a switch.

4. The method of claim 1, where the fabric network comprises two or more stages of network devices.

5. The method of claim 1, where the plurality of tunnels are created by packet encapsulation.

6. The method of claim 1, the fabric network connecting a plurality of racks in a data center to one or more internet access points.

7. The method of claim 1, wherein the classification of traffic groups is based at least in part on one or more header fields in the network packets and a predetermined configuration operating on said one or more header fields.

8. The method of claim 1, further comprising: inserting information into the tunnel header fields so as to increase any of a breadth and a uniformity of input values to the hash function.

9. The method of claim 1, further comprising: responsive to detection of link imbalance in the fabric network, changing information in the tunnel header fields so as to increase any of a breadth and a uniformity of input values to the hash function.

10. The method of claim 1, further comprising, applying the hash function over a set of packet header fields for the network packets, in addition to the set of tunnel header fields.

11. A system comprising at least one computer with circuitry forming a memory for storing computer program instructions and at least one processor for executing said computer program instructions, to cause the system to:
instantiate a plurality of tunnels that each traverse at least a portion of a fabric network from a first device to a second device;
receive network packets at the first device, and classifying the network packets into a plurality of traffic groups based at least in part on information in the network packets;
place network packets for a given traffic group into at least one tunnel of the plurality of tunnels;
assign each of the plurality of tunnels to an outbound link on the first device, at least in part by applying an equal cost multi path (ECMP) algorithm to a set of tunnel header fields, wherein applying the ECMP algorithm comprises applying a hash function over at least the set of tunnel header fields; and,
transmit network packets in each tunnel from the respective assigned outbound link over a next hop in the fabric network.

12. The system of claim 11, where said instantiating, receiving, assigning, and transmitting are performed on-demand, in response to a detection of link imbalance in a fabric network.

13. The system of claim 11, where the first device comprises any of: a router and a switch.

14. The system of claim 11, where the fabric network comprises two or more stages of network devices.

15. The system of claim 11, where the plurality of tunnels are created by packet encapsulation.

16. The system of claim 11, wherein the classification of traffic groups is based at least in part on one or more header fields in the network packets and a predetermined configuration operating on said one or more header fields.

17. The system of claim 11, further comprising: insert information into the tunnel header fields so as to increase any of a breadth and a uniformity of input values to the hash function.

18. The system of claim 11, further comprising: responsive to detection of link imbalance in the fabric network, change information in the tunnel header fields so as to increase any of a breadth and a uniformity of input values to the hash function.

19. The system of claim 11, further comprising, apply the hash function over a set of packet header fields for the network packets, in addition to the set of tunnel header fields.

20. Non-transitory computer readable medium comprising program code for execution one at least one hardware processor to cause at least one computer to perform steps comprising:
instantiating a plurality of tunnels that each traverse at least a portion of a fabric network from a first device to a second device;
receiving network packets at the first device, and classifying the network packets into a plurality of traffic groups based at least in part on information in the network packets;
placing network packets for a given traffic group into at least one tunnel of the plurality of tunnels;
assigning each of the plurality of tunnels to an outbound link on the first device, at least in part by applying an equal cost multi path (ECMP) algorithm to a set of tunnel header fields, wherein applying the ECMP algorithm comprises applying a hash function over at least the set of tunnel header fields; and,
transmitting network packets in each tunnel from the respective assigned outbound link over a next hop in the fabric network.
